(19) United States
(12) Patent Application Publication
(10) Pub. No.: US 2025/0192950 A1
(43) Pub. Date: Jun. 12, 2025

(54) METHODS FOR DEMODULATION REFERENCE SIGNALLING AND RELATED DEVICES AND NODES

(71) Applicant: Sony Group Corporation, Tokyo (JP)

(72) Inventors: Fredrik RUSEK, Eslöv (SE); Erik BENGTSSON, Eslöv (SE); Chaitanya TUMULA, Åkarp (SE)

(21) Appl. No.: 18/847,235

(22) PCT Filed: Mar. 20, 2023
(86) PCT No.: PCT/EP2023/056999

§ 371 Date: Sep. 14, 2024

(30) Foreign Application Priority Data
Mar. 31, 2022 (SE) 2250404-7

(51) Int. Cl. H04L 5/00

(52) U.S. Cl. CPC H04L 5/0051; H04L 5/0091

(57) ABSTRACT

Disclosed is a method, performed by a network node, for demodulation reference signalling. The method comprises transmitting, to a wireless device, control signalling indicative of layer configuration associated with an upcoming demodulation reference signal, DMRS. The layer configuration comprises a type of layer. The type of layer can comprise a data layer, and/or an interference layer.

The present disclosure pertains to the field of wireless communications. The present disclosure relates to methods for demodulation reference signalling, a related wireless device, and a related network node.

### BACKGROUND

In 3^{rd} Generation Partnership Project, 3GPP, New Radio, NR, some constellations for modulation can be used. The constellations are complex-valued except for Binary Phase Shift Keying, BPSK. Other known constellations are not used.

### SUMMARY

There is a need to extend the constellations suitable for use in NR and following generations of wireless communication systems. Indeed, in some use-cases, it has been identified by this disclosure that it is suitable to employ M-Pulse Amplitude Modulation, M-PAM alphabets, where M is a positive integer (such as 4-PAM, 8-PAM etc.). Also for example, two wireless devices can share one Quadrature Amplitude Modulation transmission (a first wireless device decodes the real part, and the second wireless device decodes the imaginary part). Such setup can be used for example in non-orthogonal multiple access, NOMA and/or in multi-user Multiple Input Multiple Output, MIMO. The present disclosure allows the wireless devices to know what to decode and what is interference, based on appropriate Demodulation Reference Signals and associated signalling.

Accordingly, there is a need for devices and methods for demodulation reference signalling, which may mitigate, alleviate, or address the shortcomings existing in the state of the art and may provide benefits of real-valued modulation using a general M-PAM constellation.

Disclosed is a method, performed by a network node, for demodulation reference signalling. The method comprises transmitting, to a wireless device, control signalling indicative of layer configuration associated with an upcoming demodulation reference signal, DMRS. The layer configuration may comprise a type of layer. The type of layer may comprise a data layer, and/or an interference layer. In other words, the type of layer may comprise a first type of layer indicative of a data layer, and/or a second type of layer indicative of an interference layer.

Further, a network node comprising memory circuitry, processor circuitry, and a wireless interface is provided. The network node is configured to perform any of the methods disclosed herein.

It is an advantage of the present disclosure that the disclosed method and disclosed network node enable the wireless device to obtain interference parameters allowing interference to be mitigated. The present disclosure allows flexible resource allocation at the network node. This can enable the wireless device to benefit from real-valued modulation using a general M-PAM constellation, for example in terms of higher spectral efficiency. In some examples, M-PAM can be seen as sharing what is in QAM constellation.

Disclosed is a method, performed by a wireless device, for demodulation reference signalling. The method comprises receiving, from a network node, control signalling indicative of layer configuration associated with an upcoming demodulation reference signal, DMRS. The layer configuration can comprise a type of layer. The type of layer can comprise (e.g. can be indicative of) a data layer, and/or an interference layer.

Further, a wireless device comprising memory circuitry, processor circuitry, and a wireless interface, is provided. The wireless device is configured to perform any of the methods disclosed herein.

It is an advantage of the present disclosure that the disclosed method and disclosed wireless device can obtain interference parameters allowing interference to be mitigated. The present disclosure allows flexible resource allocation from the network node. This can lead to the wireless device benefitting from real-valued modulation of a generalized M-PAM, for example in terms of higher spectral efficiency.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating an example wireless communication system comprising an example network node, an example coverage enhancing device and an example wireless device according to this disclosure,

FIG. 3 is a diagram illustrating an example wireless communication system comprising an example network node and an example wireless device according to this disclosure,

FIG. 4 is a signalling diagram illustrating an example communication between an example network node, and an example wireless device according to this disclosure

FIG. 5 is a flow-chart illustrating an example method, performed by a network node, for demodulation reference signalling according to this disclosure,

FIG. 6 is a flow-chart illustrating an example method, performed by a wireless device for demodulation reference signalling according to this disclosure,

FIG. 7 is a block diagram illustrating an example network node according to this disclosure, and

FIG. 8 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

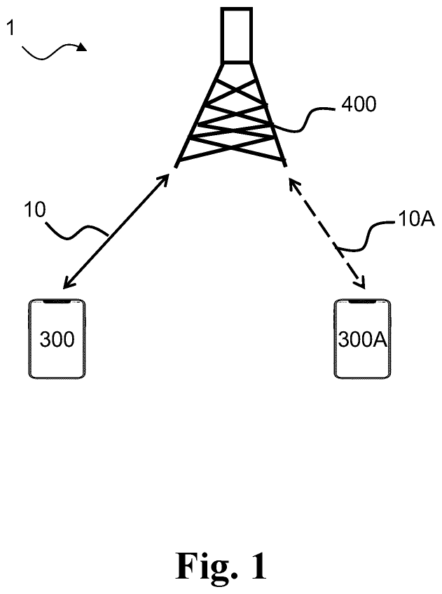

FIG. 1 is a diagram illustrating an example wireless communication system 1 comprising an example network node 400 and an example wireless device, WD, 300 according to this disclosure.

As discussed in detail herein, the present disclosure relates to a wireless communication system 1 comprising a cellular system, for example, a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB in NR. In one or more examples, the RAN node is a functional unit which may be distributed across several physical units.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless device 300, 300A may be configured to communicate with the network node 400 via a wireless link (or radio access link) 10, 10A.

In some instances, the network node can be seen as transmitting 3 layers or streams. In other words, the network node transmits 3 independent complex valued data symbols drawn from a complex-valued alphabet such as 16-QAM.

The terms “layer” and “stream” can be used interchangeably and may be seen as a sequence of data symbols. One or more layers can be derived from a single codeword.

For example, a layer can be seen as the dimensionality of the raw (e.g., non-precoded) data vector in each resource element. For example, for N layers (or N streams), in every resource element, the transmitted signal is a transformation of N numbers that contain data (such as a linear transformation). For example, the transformation produces N or more than N numbers. The transformation may be the identity-transformation. For example, each of the N numbers comes from the same or different constellation.

In a multiuser system with for example 2 WDs, the network node can for example send 1 layer to WD1 and the remaining 2 layers to WD2. However, this can be seen as creating an unbalanced situation, such as an asymmetric situation, such as a situation with uneven distribution. With 3 WDs, the network node is to assign 1 layer to each of the WDs, which provides a limited freedom in its resource scheduling.

However, a complex valued layer can be viewed as 2 real-valued layers. It can be seen that with 3 complex-valued layers, there are actually 6 real-valued layers to be assigned to the WDs. With 2 WDs, a more balanced transmission can be achieved by assigning 3 real-valued layers to each of the WDs. Another approach can be to send 5 layers to WD1 and a single layer to WD2. With 3 UEs, there are many more possibilities. For example (3,2,1) (layers/per UE) and so on.

Stated differently, by assigning real-valued layers to the WDs, more flexibility in the resource allocation can be obtained.

In order to fully benefit from the flexibility in resource allocation, it is advantageous to make use of real-valued constellations. In NR, the only real-valued constellation is BPSK, but BPSK offers low spectral efficiency, and thereby low data rate.

The present disclosure allows extension of the modulation schemes to include in the 3GPP communication system and benefit from a generic M-ary PAM constellation, which leads to a more flexible and/or fair resource allocation.

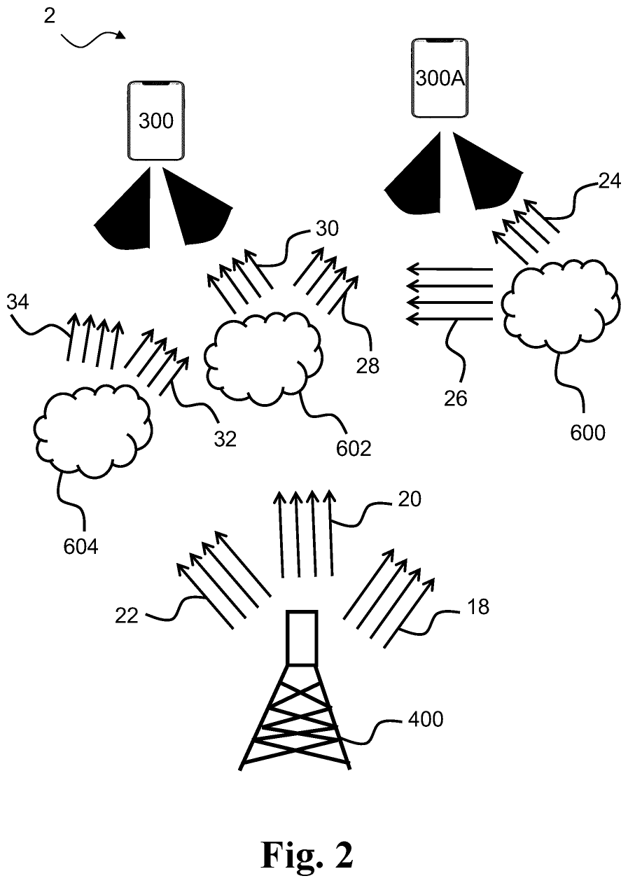

FIG. 2 is a diagram illustrating an example wireless communication system 2 comprising an example network node 400, and an example wireless device 300 according to this disclosure.

The wireless communication system 2 comprises a wireless device 300, a wireless device 300A and/or a network node 400.

The wireless communication system 3 may comprise one or more wireless devices 300, 300A, and/or one or more network nodes 400, such as one or more of: a base station, an eNB, a gNB and/or an access point.

The wireless device 300, 300A may be configured to communicate with the network node 400 via a wireless link (or radio access link).

For example, three propagation path components 600, 602, 604 are illustrated between the network node 400 and the wireless devices 300, 300A in FIG. 2. For example, a propagation path component can be a reflection. There is no Line-of-Sight, LoS, between the network node 400 and each of the wireless devices 300,300A.

For example, each wireless device comprises two beams (such as two ports). In other words, the, signals sent by the network node 400, may be received in the two beams of each wireless device, such as the wireless devices 300, 300A. For example, the composite channel matrix between the network node 400 and the wireless devices 300, 300A has rank 3. In other words, only three complex-valued streams can be sent over the communication channel. There are three channel inputs, such as the signals sent in the three beams of the network node 400, and four outputs, such as the signals received in the two beams of each wireless device 300, 300A.

For example, with a suitable matrix decomposition, the input-output relation can be described by a 4×3 complex-valued matrix.

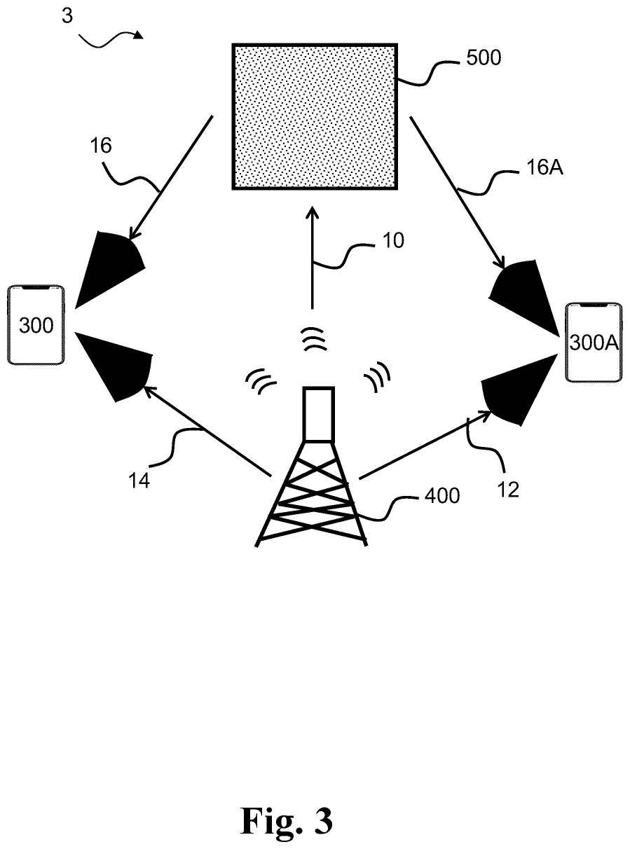

It may be appreciated that the wireless communication system 2 may comprise various entities, as illustrated by wireless communication system 3 of FIG. 3.

FIG. 3 is a diagram illustrating an example wireless communication system 2 comprising an example network node 400, an example coverage enhancing device, CED, 500 and an example wireless device 300 according to this disclosure.

For example, the example wireless communication system 3 can be seen a generalized version of the example wireless communication system 2 disclosed in FIG. 2 with a CED.

The wireless communication system 3 comprises a wireless device 300 and/or a network node 400 and/or a coverage enhancing device, CED, 500.

The wireless communication system 3 may comprise one or more wireless devices 300, 300A, and/or one or more network nodes 400, such as one or more of: a base station, an eNB, a gNB and/or an access point, and/or one or more coverage enhancing devices, CEDs, 500, such as reconfigurable intelligent surfaces (RISs), large intelligent surfaces (LISs), network configured repeaters, repeater nodes, repeater type devices, repeaters (such as regenerative and/or non-regenerative), intelligent surfaces, and reconfigurable reflective devices (RRDs).

The wireless device 300, 300A may be configured to communicate with the network node 400 via a wireless link (or radio access link) 14, 12 respectively. The wireless device 300, 300A may be configured to communicate with the network node 400 via their respective wireless links using at least one respective beam as illustrated in FIG. 3.

A CED-assisted signaling to two wireless devices is provided. The WD 300 may receive signals from the CED 500 via wireless link 16 and using at least one beam in the direction illustrated in FIG. 3. The WD 300A may receive signals from the CED 500 via wireless link 16A and using at least one beam in the direction illustrated in FIG. 3. For example, the CED 500 send a signal to both WD 300 and 300A, but with less power than if the signal was only redirected to one of the WDs.

There may be Line of Sight (LoS) among the network node, the CED 500 and the wireless devices 300, 300A. The network node 400 may transmit using three beams (also known as ports), to reach the wireless device 300 and the wireless device 300A, using the direct paths 12, 14, or via the CED 500 via a wireless link (or radio access link) 10, which can cause crosstalk effects.

For example, the wireless device 300 may suffer from crosstalk. In other words, the wireless device 300 receives from the network node 400 two signals (such as 2 ports) and two signals from the CED 500. For example, the two signals from the CED 500 and the network node 400 are the same signals but received in two ports at the WD 300.

The wireless devices 300, 300A comprise two beams (such as ports). The input-output relation, such as the channel matrix, can be described as a complex-valued 4×3 matrix. In other words, for example, the complex-valued matrix represents three channel inputs, such as the signals sent in the three beams of the network node 400, and four outputs, such as the signals received in the two beams of each wireless device, such as the wireless device 300 and the wireless device 300A.

For example, the input-output relation can be described as a complex-valued 4×3 matrix, with a rank 3. In other words, only 3 complex-valued streams can be sent over the communication channel. An unbalanced distribution among the wireless devices 300, 300A may arise when complex-valued layers are to be distributed. In other words, one option may be to have the wireless device 300 receiving two complex-valued layers and the wireless device 300A receiving one complex-valued layer. Another option is to have the wireless device 300A receiving two complex-valued layers and the wireless device 300 receiving one complex-valued layer. The present disclosure provides a technique that avoids having this unbalanced situation between WDs.

It may be seen that the wireless communication systems 2, 3 deal with similar communication challenges, thus the observations for the wireless communication system 3 may be applicable for the wireless communication system 2.

The present disclosure demonstrates with the disclosed technique that real-valued layers provides benefits in generic cases, not only in specific cases.

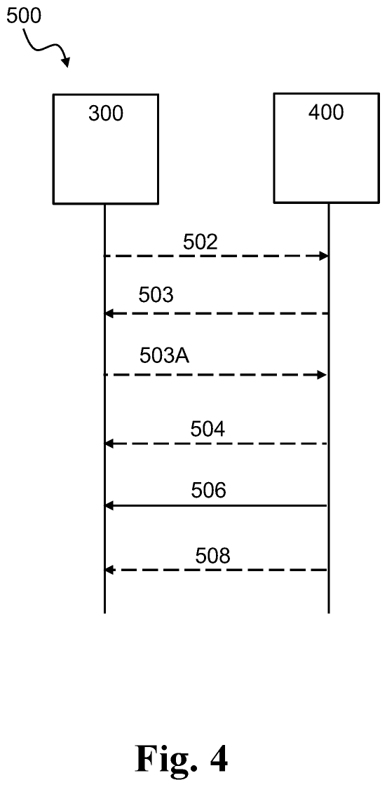

FIG. 4 is a signalling diagram 500 illustrating an example communication between an example network node 400, and an example wireless device 300 according to this disclosure.

The wireless device 300 can transmit, to the network node 400, information 502 indicative of a capability of the wireless device for supporting a layer configuration. For example, information 502 may be seen as capability information. Information 502 may be exchanged during registration of the WD 300 with the network.

Beam management (such as one or more of: beam sweeping, beam measurement, beam determination, beam selection, and beam reporting) can be performed. Beam management can be performed prior to beam identification in some examples.

For example, the network node 400 performs beam sweeping 503 with the WD 300. In other words, the network node 400 can transmit multiple beams in predefined directions. For example, the beam sweeping can cover a spatial area with a set of beams transmitted and received according to pre-specified intervals and directions.

In some examples, the wireless device 300 performs beam reporting 503A to the network node 400. In other words, the wireless device 300 selects and reports the most appropriate beam(s) to the network node 400. For example, the WD 300 can send beam quality and beam decision information to the network node 400.

The network node 400 can transmit Modulation and Coding Scheme, MCS, information 504, to the wireless device 300. For example, the MCS information indicates to the WD how many layers that are to be communicated and what MCS or constellation are to be used. For example, a separate signalling can be sent for indicating to the WD how many layers that are to be communicated.

The network node 400 transmits, to the wireless device, control signalling 506 indicative of layer configuration associated with an upcoming DMRS. For example, control signalling 506 can include DMRS information which indicates the number of DMRS-ports to be expected, and/or indicates if the DMRSs relate to data layers or interference layers, and if any DMRS should be applied to more than one layer, such as two layers. For example, the DMRS(s) is sent together with data, such as in a Physical Downlink Shared Channel, PDSCH and in a Physical Downlink Control Channel, PDCCH.

The network node 400 can generate, based on the layer configuration, one or more DMRSs 508 and can transmit the one or more DMRSs 508 to the wireless device 300. The wireless device 300 receives, from the network node 400, the one or more DMRSs 508 generated based on the layer configuration.

The wireless device 300 can determine, based on the layer configuration, inter-user interference parameters from the one or more DMRS 508. The wireless device 300 can determine, based on the layer configuration and the one or more DMRSs, one or more channel estimation parameters. The wireless device 300 can obtain, based on the one or more channel estimation parameters, demodulated data.

The present disclosure may not be limited to the examples of FIGS. 2 and 3 and can be applied to many more cases, for example with many more WDs, more ports, more propagation path components.

For example, the channel matrix between the wireless devices, such as the wireless device 300 and the wireless device 300A, and the network node 400 may be expressed as:

$$H = [ \begin{matrix}{H}_{1} \\ {H}_{2}\end{matrix} ] \qquad ( 1 )$$

where H concatenates the channel matrices of the wireless device 300 and the wireless device 300A. H can for example be characterized by a 4×3 real-valued matrix for the examples of FIGS. 2 and 3; and Hₖ is the channel matrix to the k:th wireless device, of dimension 2×3, wherein k∈{1,2}.

For example, from the real-valued perspective, Equation (1) may be expressed as:

$${H}_{r} = [ \begin{matrix}R ( {H}_{1} ) & - I ( {H}_{1} ) \\ I ( {H}_{1} ) & R ( {H}_{1} ) \\ R ( {H}_{2} ) & - I ( {H}_{2} ) \\ I ( {H}_{2} ) & R ( {H}_{2} )\end{matrix} ] = [ \begin{matrix}{H}_{r , 1} \\ {H}_{r , 2}\end{matrix} ] \qquad ( 2 )$$

where R(⋅) and I(⋅) denote the real and imaginary parts of the channel matrix of both the wireless device 300 and the wireless device 300A, respectively;

Hᵣ denotes the total channel matrix, concatenating the channel matrices of the wireless device 300 and the wireless device 300A. For example, Hᵣ can be characterized by a 8×6 real-valued matrix for examples of FIGS. 2 and 3; and

H_{r,1} and H_{r,2} denote the channel matrix, for the wireless device 300 and the wireless device 300A, respectively. For example, H_{r,1} and H_{r,2} are expressed as 4×6 real-valued matrices in examples of FIGS. 2 and 3.

For example, both the wireless device 300 and the wireless device 300A may be intended to receive 3 real-valued M-PAM symbols from the network node 400. The signal transmitted, to the wireless device 300 and the wireless device 300A, by the network node 400 may be expressed as:

$$s = [ \begin{matrix}{N}_{2} {Q}_{1} & {q}_{1} & {N}_{1} {Q}_{2} & {q}_{2}\end{matrix} ] [ \begin{matrix}{x}_{1} \\ {x}_{2}\end{matrix} ] \qquad ( 3 )$$

where x₁ and x₂ denote 3×1 vectors comprising the data to the wireless device 300 and the wireless device 300A, respectively in examples of FIGS. 2 and 3. The vectors x₁ and x₂ may be obtained from M-PAM constellations;
N₁ and N₂ denote basis matrices (which can be of dimension 6×2, in examples of FIGS. 2 and 3) for the null spaces of H_{r,1} and H_{r,2}, respectively. Stated differently, N₁ and N₂ may be seen as matrices for zero forcing purposes. In other words, H_{r,k}Nₖ=0;
Q₁ and Q₂ denote pre-determined matrices (which can be of dimension 2×2 in examples of FIGS. 2 and 3), which may be optimized and provided by the network node 400; and
q₁ and q₂ denote pre-determined vectors (which can be of dimension 6×1 in examples of FIGS. 2 and 3), which may be provided by the network node 400.

For example, the signal received by the wireless device 300 and the wireless device 300A, respectively, in the absence of noise, may be expressed as:

$${r}_{1} = {H}_{r , 1} s = {H}_{r , 1} [ \begin{matrix}{N}_{2} {Q}_{1} & {q}_{1} & {q}_{2}\end{matrix} ] [ \begin{matrix}{x}_{1} \\ {x}_{2 , 3}\end{matrix} ] = {E}_{1} [ \begin{matrix}{x}_{1} \\ {x}_{2 , 3}\end{matrix} ] \qquad ( 4 )$$

$${r}_{2} = {H}_{r , 2} s = {H}_{r , 2} [ \begin{matrix}{q}_{1} & {N}_{1} {Q}_{2} & {q}_{2}\end{matrix} ] [ \begin{matrix}{x}_{1 , 3} \\ {x}_{2}\end{matrix} ] = {E}_{2} [ \begin{matrix}{x}_{1 , 3} \\ {x}_{2}\end{matrix} ] \qquad ( 5 )$$

where E₁ and E₂ denote real-valued full rank matrices (which can be 4×4);
x_{2,3} denotes the interference layer, such as a stream, intended to the wireless device 300A, which acts as interference to the wireless device 300; and
x_{1,3} denotes the interference layer, such as a stream, intended to the wireless device 300, which acts as interference to the wireless device 300A.

For example, E₁ and E₂ are of dimension 4×4. This can lead to a substantial reduction of the inter-user interference. In other words, a proper selection of the matrices Q₁ and Q₂, and the vectors q₁ and q₂ by the network can improve the overall performance of the wireless communication system.

In other words, when the network node 400 sends 3 complex-valued layers, such as three complex-valued streams, (e.g., in NR layers using QAM) to the wireless device 300 and the wireless device 300A, it may be appreciated to have such layers properly distributed among the wireless devices. For example, a proper distribution of the layers may be attained by sending to each of the two wireless devices, such as wireless device 300 and the wireless device 300A, the three real-valued layers, such as three real-valued streams. This can lead to mitigation of inter-user interference among the wireless devices, resulting in a more balanced and flexible distribution, thereby improving substantially the respective resource allocation at network node.

The disclosed technique may be expressed in a generic manner. For example, when K complex-valued layers are to be sent from the network node, 2K real-valued layers can be readily distributed across the wireless devices.

For each wireless device, there may be several data layers and interference layers. For example, in view of the disclosed derivations, the first 3 columns of E₁ correspond to the data layers, while the fourth column corresponds to an interference layer. For example, for a first wireless device, such as WD 300 or UE1 in Matrix (7), to cancel interference, UE1 can use all 4 columns. For example, 4 DMRS can be provided by the network node. The same applied to a second wireless device, such as WD 300A or UE2 in Matrix (7).

For example, the wireless device is made aware of which DMRS relates to data layers and which DMRS relates to interference layers. For example, the network node 400 indicates the relation to the wireless device by transmitting control signalling indicative of layer configuration for an upcoming DMRS.

In one or more examples, the network node provides the pre-determined matrices Q₁ and Q₂ to the wireless device. This allows for simplified derivations. For example, the two pre-determined matrices can be taken by default as Q₁=Q₂=I, where I represents a scaled identity matrix (e.g., A*[1 0;0 1] where A is a constant that normalizes transmit power). For example, the effective channel matrices E₁ and E₂ take a special form, for example:

$$E = [ \begin{matrix}{E}_{1} \\ {E}_{2}\end{matrix} ] = [ \begin{matrix}a & - b & {e}_{13} & 0 & 0 & 0 \\ 0 & 0 & {e}_{23} & 0 & 0 & {J}_{1} \\ b & a & {e}_{33} & 0 & 0 & 0 \\ 0 & 0 & {e}_{43} & 0 & 0 & {J}_{2} \\ 0 & 0 & 0 & c & - d & {e}_{56} \\ 0 & 0 & {I}_{1} & 0 & 0 & {e}_{66} \\ 0 & 0 & 0 & d & c & {e}_{76} \\ 0 & 0 & {I}_{2} & 0 & 0 & {e}_{86}\end{matrix} ] \qquad ( 6 )$$

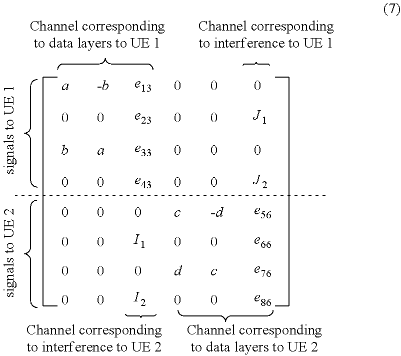

Matrix (7) shows that channels corresponding to the first two layers to UE1 corresponding to the wireless device 300 have the disclosed form.

To obtain channel estimation parameters indicative of the first channel, the first column, can be sufficient as the second column is given from the first. The same argument applies for columns 4 and 5 for UE2 or the wireless device 300A.

For example, the two first columns do not affect UE1 or wireless device 300A and, columns 4 and 5 do not affect UE2 or wireless device 300.

It may be appreciated that a single DMRS symbol can be sufficient to learn the 4 columns (2 columns are estimated at UE1 or wireless device 300 and the other 2 at UE2 or wireless device 300A).

For example, with Matrix (7), the network node is to generate, based on the layer configuration the DMRS. For example the network node can generate, based on the layer configuration, a reference symbol or DMRS indicator indicative of the DMRS mapping determined based on the layer configuration. The reference symbol and/or DMRS indicator can have a form, such as: x= [1 0 0 1 0 0]^{T}

For example, the network node generates, based on the layer configuration, the next DMRS. For example the network node can generate, based on the layer configuration, a reference symbol or DMRS indicator indicative of the DMRS mapping determined based on the layer configuration. The reference symbol and/or DMRS indicator for the next DMRS can be expressed such as: x= [0 0 1 0 0 0]^{T}, which allows the wireless device 300 to obtain the third column, while the wireless device 300A can learn the interference channel. For example, the network node generates, based on the layer configuration, a third DMRS. For example, the network node can generate, based on the layer configuration, a reference symbol or DMRS indicator indicative of the DMRS mapping determined based on the layer configuration. The reference symbol and/or DMRS indicator for the third DMRS can be expressed e.g.: x= [0 0 0 0 0 1]^{T} which allows the wireless device 300 to obtain its interference channel, while the wireless device 300A obtains its final data layer. It may be appreciated that in one or more examples, only 3 DMRS are needed.

In one or more examples, the present disclosure proposes that the network node indicates to each of the wireless devices 300, 300A the layer configuration for an upcoming DMRS. The layer configuration can indicate for example one or more of: the number of layers, the relation between layers, and the type of layer (e.g. indicative of interference layer and/or data layer).

For example, the layer configuration can indicate two layers with a relation between them, such as the two first layers for wireless device 300 and the wireless device 300A, such as two interference layers. The relation can indicate that two real-valued layers can be seen as one complex-valued layer.

Matrix (7) can be extended based on the number of WDs, and capture interference and data layers.

For example, the layer configuration can indicate a single layer, such as a layer for both the wireless device 300, 300A.

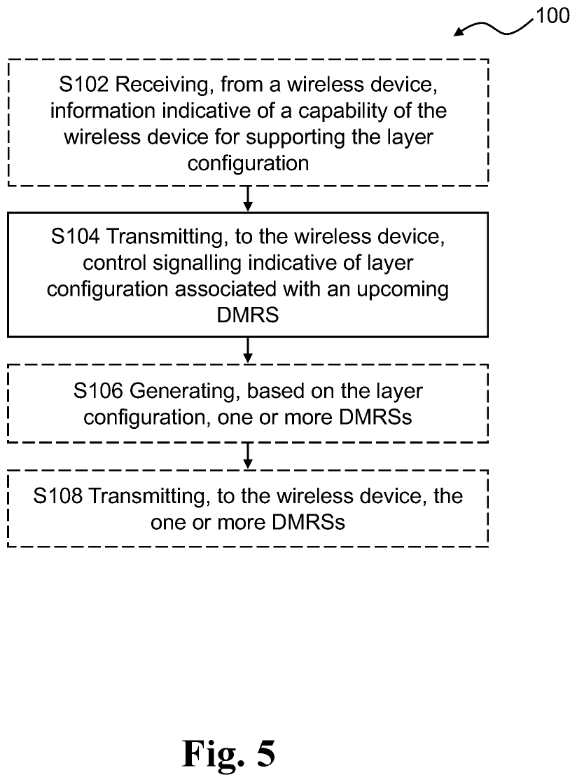

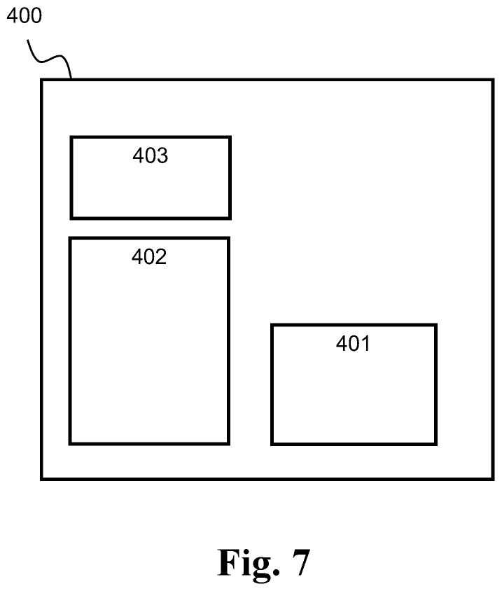

FIG. 5 is a flow-chart illustrating an example method 100, performed by a network node, for demodulation reference signalling according to this disclosure. The network node is the network node disclosed herein, such as a network node 400 of FIG. 1, FIG. 2, FIG. 3, and FIG. 7.

The method 100 comprises transmitting S104, to a wireless device, control signalling indicative of layer configuration associated with an upcoming demodulation reference signal, DMRS. A DMRS can be seen as a pilot signal for demodulation and/or a reference signal for demodulation.

The layer configuration may be seen as a configuration or a set of parameters indicating features of the layer(s), such as number of layer and/or type of layers and/or layer relation(s).

The layer configuration may comprise a type of layer. The type of layer can comprise (e.g. indicative of) a data layer, and/or an interference layer. For example, the type of layer comprises a type indicative of a complex-valued layer, and/or a type indicative of a real-valued layer.

The interference layer can be seen as an inter-user interference layer, meaning, a layer carrying data not intended for a desired user or a desired WD or a current WD. The interference layer can be seen as an unwanted layer” and/or a “non-data-bearing layer”. In one or more example methods, the layer configuration comprises a relation between layers and/or a mapping to a DMRS port. A DMRS port may be seen as a port associated with a beam and/or a spatial filter and/or a direction. A DMRS port can be defined as an antenna port through which DMRS signals are transmitted. The same antenna port through which DMRS signals are transmitted can also be used to transmit a specific layer or stream (e.g. mapping the DMRS port to a layer). An antenna port is defined such that the channel over which a symbol on the antenna port is conveyed can be inferred from the channel over which another symbol on the same antenna port is conveyed.

In one or more example methods, the type of layer comprises (e.g. is indicative of) a complex-valued layer, and/or a real-valued layer. For example, the network node can indicate to the WD that real-valued layers are to be sent. This can exploit different constellations in different layers, allowing M-PAM to be readily implemented. In some examples, M-PAM is with M being a positive integer larger than 2.

In one or more example methods, the layer configuration comprises a layer index. The control signalling can be indicative of the layer index. The layer index can be seen as a parameter indexing the layer configuration to indicate a data layer and/or an interference layer.

The control signalling may be as control signalling 506 illustrated in FIG. 4. The control signalling indicative of layer configuration associated with an upcoming DMRS can be in form of a flag and/or one or more control messages. For example the flag may be seen as an implicit signalling indicating to the wireless device the layer configuration for the upcoming DMRS(s). The one or more control messages can be indicating to the wireless device the layer configuration for the upcoming DMRS(s). The one or more control messages can include an information indicating to the wireless device the layer configuration for the upcoming DMRS(s).

In one or more example methods, the method 100 comprises receiving S102, from the wireless device, information indicative of a capability of the wireless device for supporting the layer configuration, such as for interpretation of a layer configuration indication. For example, the information indicative of the capability includes a number of layers supported by the wireless device, and/or interference cancellation capability of the wireless device. The information can be illustrated as information 502 of FIG. 4. The network node can receive the information about the capability, and optionally can perform beam management and send MCS information to the wireless device before transmitting the control signalling indicative of the layer configuration.

In one or more example methods, the method 100 comprises generating S106, based on the layer configuration, one or more DMRSs. For example the one or more DMRSs comprise a first DMRS, a second DMRS and optionally a third DMRS, and optionally a fourth DMRS. For example, the network node can generate, based on the data layer indicated in the layer configuration, a first DMRS. For example, the network node can indicate the DMRS port mapping via DMRS port indicator and/or DMRS indicators, such as:

$$x = {[ \begin{matrix}1 & 0 & 0 & 1 & 0 & 0\end{matrix} ]}^{T}$$

For example, the network node can generate, based on the interference layer for interferences by the WD (UE1) and perceived by another WD (UE2), a second DMRS (possibly following the first DMRS). For example, the network node can indicate the DMRS port mapping via DMRS port indicator and/or, DMRS indicators, such as: x= [0 0 1 0 0 0]^{T}.

For example, the network node can generate, based on the interference layer for interferences by another WD (UE2) and perceived by the WD (1), a third DMRS (possibly following the second DMRS and/or the first DMRS), For example, the network node can indicate the DMRS port mapping via DMRS port indicator and/or, DMRS indicators, such as: x= [0 0 0 0 0 1]^{T}.

In one or more example methods, the method 100 comprises transmitting S108, to the wireless device, the one or more DMRSs. For example, the network node transmits a first DMRS, such as DMRS 508 of FIG. 4, and optionally a second DMRS. Upon receiving the first DMRS, UE1 can obtain the data. Upon receiving the second DMRS, UE1 can obtain channel estimation parameters, while UE 2 can obtain inter-user interference parameters. For example, the third DMRS can allow UE1 to acquire information about its interference channel (for example obtain inter-user interference parameters), while UE2 obtains the channel estimates associated with its data layer. This is illustrated in by the third and sixth column of Matrix (7).

For example, the DMRS is a sequence of N numbers where N is a positive integer. For example, the sequence can include 3 numbers, such as [1 i (1+i)]. For example, the network node can send three vectors x such as: [1 0 0 1 0 0], and then [0 1 0 0 1 0], and finally [1 1 0 1 1 0]. In other words, vector x indicates a weighting of the DMRS.

For example, two remaining x-vectors (the ones with a single non-zero entry) cannot represent complex DMRS. For example, DMRS sequences can be provided for real-valued constellations. For example, the DMRS vector [1 −1 1] which would produce the following transmitted DMRS signals: [0 0 1 0 0 0], [0 0 −1 0 0 0] [0 0 1 0 0 0]; and then [0 0 0 0 0 1], [0 0 0 0 0 −1], [0 0 0 0 0 1].

For example, each DMRS port transmits multiple DMRS interleaved with data symbols in the frequency and time.

In one or more example methods, at least one of the one or more DMRS is indicative of the interference layer. In one or more example methods, at least one of the one or more DMRS is indicative of the data layer. In one or more example methods, at least one of the one or more DMRS is indicative of the interference layer and the data layer.

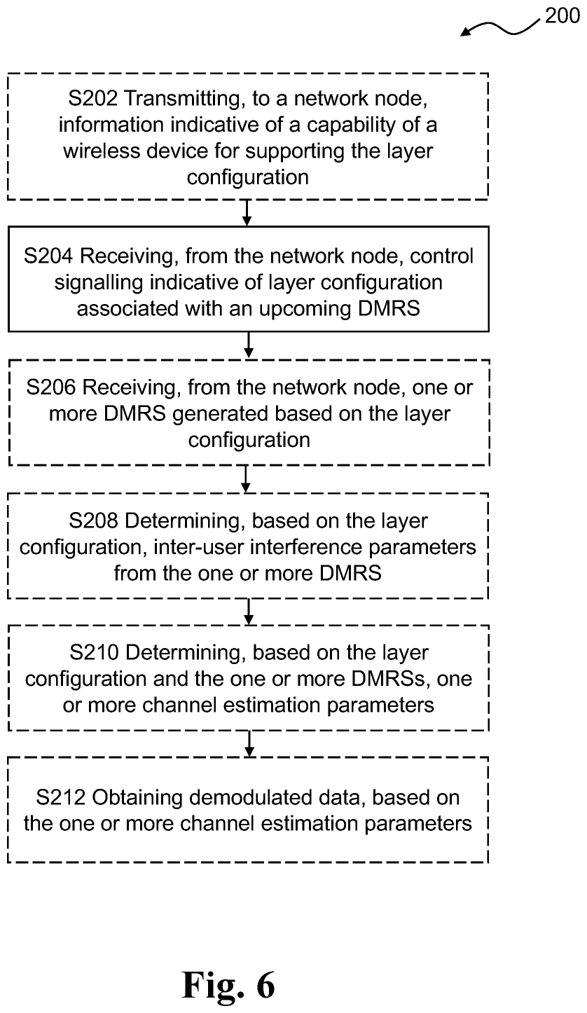

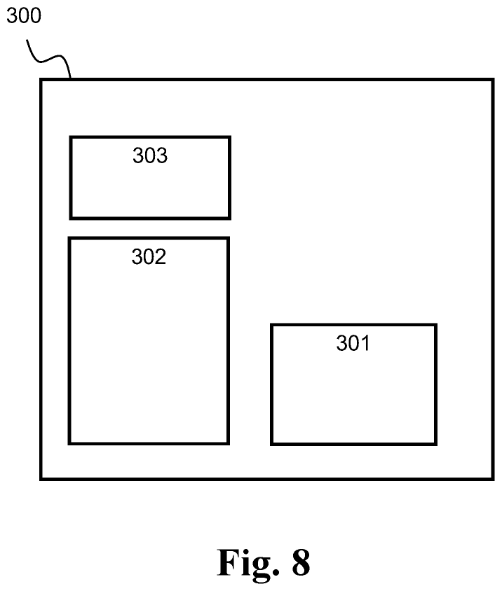

FIG. 6 is a flow-chart illustrating an example method 200, performed by a wireless device, for demodulation reference signalling according to this disclosure. The wireless device is a wireless device disclosed herein, such as a wireless device 300 of FIG. 1, FIG. 2, FIG. 3, and FIG. 8.

The method 200 comprises receiving S204, from a network node, control signalling indicative of layer configuration associated with an upcoming demodulation reference signal, DMRS. The layer configuration comprises a type of layer. The type of layer can comprise (e.g. can be indicative of) a data layer, and/or an interference layer. For example, the network node receives control signalling transmitted in S104 of FIG. 5.

In one or more example methods, the layer configuration comprises a relation between layers and/or a mapping to a DMRS port. In one or more example methods, the type of layer comprises (e.g. can be indicative of) a complex-valued layer, and/or a real-valued layer. In one or more example methods, the layer configuration comprises a layer index.

In one or more example methods, the method 200 comprises transmitting S202, to the network node, information indicative of a capability of the wireless device for supporting the layer configuration. This may correspond to S102 of FIG. 5.

In one or more example methods, the method 200 comprises receiving S206, from the network node, one or more DMRS generated based on the layer configuration. This may correspond to S108 of FIG. 5.

In one or more example methods, the method 200 comprises determining S208, based on the layer configuration, inter-user interference parameters from the one or more DMRSs.

For example, the inter-user interference parameters (such as J1, J2 for UE1 in Matrix (7)) are used for cancelling interference in data signals and in DMRS signals.

In one or more example methods, the method 200 comprises determining S210, based on the layer configuration and the one or more DMRSs, one or more channel estimation parameters. This is illustrated in Matrix (7) by elements e_{xy}.

In one or more example methods, the method 200 comprises obtaining S212 demodulated data, based on the one or more channel estimation parameters.

For example, the WD receives the DMRS(s), estimates channel estimation parameters which are real-valued, constructs an equalizer, e.g., a zero forcing, ZF, equalizer, and demodulates the data.

FIG. 7 shows a block diagram of an example network node 400 according to the disclosure. The network node 400 comprises memory circuitry 401, processor circuitry 402, and a wireless interface 403. The network node 400 may be configured to perform any of the methods disclosed in FIG. 5. In other words, the network node 400 may be configured for interference coordination for side-link communication between a first and a second User Equipment, UE.

The network node 400 is configured to communicate with a user equipment, such as the user equipment node disclosed herein, using a wireless communication system.

The network node 400 is configured to transmit (such as via the wireless interface 403), to a wireless device, control signalling indicative of layer configuration associated with an upcoming demodulation reference signal, DMRS. The layer configuration comprises a type of layer. The type of layer can comprise (e.g. can be indicative of) a data layer, and/or an interference layer.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

Processor circuitry 402 is optionally configured to perform any of the operations disclosed in FIG. 5 (such as any one or more of S102, S106, S108). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store layer configuration, and/or beam pair information in a part of the memory.

FIG. 8 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 6. In other words, the wireless device 300 may be configured for enhancing paging of a wireless device of a set of wireless devices.

The wireless device 300 is configured to communicate with a network node, such as the wireless device disclosed herein, using a wireless communication system.

The wireless device 300 is configured to receive (such as via the wireless interface 303), from a network node, control signalling indicative of layer configuration associated with an upcoming demodulation reference signal, DMRS. The layer configuration comprises a type of layer. The type of layer can comprise (e.g. can be indicative of) a data layer, and/or an interference layer.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The wireless device 300 is optionally configured to perform any of the operations disclosed in FIG. 6 (such as any one or more of S202, S206, S208, S210, S212). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 8). Memory circuitry 301 is considered a non-transitory computer readable medium.

Memory circuitry 301 may be configured to store layer configuration, and/or beam pair in a part of the memory.

Examples of methods and products (network node and wireless device) according to the disclosure are set out in the following items:
Item 1. A method, performed by a network node, for demodulation reference signalling, the method comprising:
   transmitting (S104), to a wireless device, control signalling indicative of layer configuration associated with an upcoming demodulation reference signal, DMRS; wherein the layer configuration comprises a type of layer; wherein the type of layer comprises a data layer, and/or an interference layer.
Item 2. The method according to item 1, wherein the layer configuration comprises a relation between layers and/or a mapping to a DMRS port.
Item 3. The method according to any of the previous items, wherein the type of layer comprises a real-valued layer.
Item 4. The method according to any of the previous items, wherein the type of layer comprises a complex-valued layer.
Item 5. The method according to any of the previous items, wherein the layer configuration comprises a layer index.
Item 6. The method according to any of the previous items, the method comprising:
   receiving (S102), from the wireless device, information indicative of a capability of the wireless device for supporting the layer configuration.
Item 7. The method according to any of the previous items, the method comprising:
   generating (S106), based on the layer configuration, one or more DMRSs.
   transmitting (S108), to the wireless device, the one or more DMRSs.
Item 8. The method according to any of item 7, wherein the one or more DMRS are indicative of one or more of: the interference layer and the data layer.
Item 9. A method, performed by a wireless device, for demodulation reference signalling, the method comprising:
   receiving (S204), from a network node, control signalling indicative of layer configuration associated with an upcoming demodulation reference signal, DMRS; wherein the layer configuration comprises a type of layer; wherein the type of layer comprises a data layer, and/or an interference layer.
Item 10. The method according to item 9, wherein the layer configuration comprises a relation between layers and/or a mapping to a DMRS port.
Item 11. The method according to any of items 9-10, wherein the type of layer comprises a complex-valued layer, and/or a real-valued layer.
Item 12. The method according to any of items 9-11, wherein the layer configuration comprises a layer index.
Item 13. The method according to any of items 9-12, the method comprising:
   transmitting (S202), to the network node, information indicative of a capability of the wireless device for supporting the layer configuration.
Item 14. The method according to any of items 9-12, the method comprising:
   receiving (S206), from the network node, one or more DMRS generated based on the layer configuration.
Item 15. The method according to item 14, the method comprising:
   determining (S208), based on the layer configuration, inter-user interference parameters from the one or more DMRS.
Item 16. The method according to any of items 14-15, the method comprising:
   determining (S210), based on the layer configuration and the one or more DMRSs, one or more channel estimation parameters,
   obtaining (S212) demodulated data, based on the one or more channel estimation parameters.
Item 17. A network node comprising memory circuitry, processor circuitry, and a wireless interface, wherein the network node is configured to perform any of the methods according to any of items 1-8.
Item 18. A wireless device comprising memory circuitry, processor circuitry, and a wireless interface, wherein the wireless device is configured to perform any of the methods according to any of items 9-16.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed.

The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for demodulation reference signalling, the method comprising:
transmitting, to a wireless device, control signalling indicative of layer configuration associated with an upcoming demodulation reference signal (DMRS); wherein the layer configuration comprises a type of layer;
wherein the type of layer comprises a data layer, and/or an interference layer.

2. The method according to claim 1, wherein the layer configuration comprises a relation between layers and/or a mapping to a DMRS port.

3. The method according to claim 1, wherein the type of layer comprises a real-valued layer.

4. The method according to claim 1, wherein the type of layer comprises a complex-valued layer.

5. The method according to claim 1, wherein the layer configuration comprises a layer index.

6. The method according to claim 1, the method comprising:
receiving, from the wireless device, information indicative of a capability of the wireless device for supporting the layer configuration.

7. The method according to claim 1, the method comprising:
generating, based on the layer configuration, one or more DMRSs.
transmitting, to the wireless device, the one or more DMRSs.

8. The method according to any of claim 6, wherein the one or more DMRS are indicative of one or more of: the interference layer and the data layer.

9. A method, performed by a wireless device, for demodulation reference signalling, the method comprising:
receiving, from a network node, control signalling indicative of layer configuration associated with an upcoming demodulation reference signal (DMRS); wherein the layer configuration comprises a type of layer;
wherein the type of layer comprises a data layer, and/or an interference layer.

10. The method according to claim 9, wherein the layer configuration comprises a relation between layers and/or a mapping to a DMRS port.

11. The method according to claim 9, wherein the type of layer comprises a complex-valued layer, and/or a real-valued layer.

12. The method according to claim 9, wherein the layer configuration comprises a layer index.

13. The method according to claim 9, the method comprising:
transmitting, to the network node, information indicative of a capability of the wireless device for supporting the layer configuration.

14. The method according to claim 9, the method comprising:
receiving, from the network node, one or more DMRS generated based on the layer configuration.

15. The method according to claim 8, the method comprising:
determining, based on the layer configuration, inter-user interference parameters from the one or more DMRS.

16. The method according to claim 8, the method comprising:
determining, based on the layer configuration and the one or more DMRSs, one or more channel estimation parameters,
obtaining demodulated data, based on the one or more channel estimation parameters.

17. A network node comprising memory circuitry, processor circuitry, and a wireless interface, wherein the network node is configured to perform the method of claim 1.

18. A wireless device comprising memory circuitry, processor circuitry, and a wireless interface, wherein the wireless device is configured to perform the method of claim 9.
